(19) United States
(12) Patent Application Publication
(10) Pub. No.: US 2013/0103323 A1
(43) Pub. Date: Apr. 25, 2013

(54) TURBINE RADIAL SENSOR MEASUREMENT

(71) Applicants: David August Snider, Simpsonville, SC (US); Harold Lamar Jordan, JR., Greenville, SC (US); Christopher Ryan Holsonback, Greenville, SC (US)

(72) Inventors: David August Snider, Simpsonville, SC (US); Harold Lamar Jordan, JR., Greenville, SC (US); Christopher Ryan Holsonback, Greenville, SC (US)

(73) Assignee: GENERAL ELECTRIC COMPANY, Schenectady, NY (US)

(21) Appl. No.: 13/280,565

(22) Filed: Oct. 25, 2011

(51) Int. Cl. G06F 19/00; G01L 7/00; G06F 17/18

(52) U.S. Cl. 702/24; 702/182; 702/179; 702/50

(57) ABSTRACT

A method of measuring parameters of a gas turbine flow path is described. The method includes installing along one or more existing struts in the gas turbine flow path a first plurality of sensors for measuring a first parameter at one or more radial positions along the one or more struts and a second plurality of sensors for measuring a second parameter at one or more radial positions along the one or more struts. The method further includes producing an actual profile of the gas turbine flow path first parameter and second parameter.

### FIELD OF THE INVENTION

The present invention relates to turbines, and more particularly, to radial measurement of conditions in gas turbines.

### BACKGROUND OF THE INVENTION

With the advent of model-based controls for gas turbines, and an increasing emphasis on improving turbine performance and heat recovery steam generator (“HRSG”) life and performance, it has become desirable to have a better understanding of the gas turbines performance.

Currently, the existing production instrumentation in gas turbines typically measures performance characteristics at multiple positions circumferentially, but only at one position radially.

During the performance testing of gas turbines, it is common practice to place, at multiple circumferential positions around the frame of the turbine, rakes that measure a given parameter at a number of radial positions along the flow path. These rakes measure a more complete distribution of the gas turbine's given parameter, and can be used to define a correction to the gas turbine station's instrumentation measurement. However, these rakes are typically not robust enough to be used as long term, production instrumentation. The design of production rakes faces the challenge of being mechanically robust in a high temperature and/or flow environment, with concerns of dynamic responses. In addition, any such design must have a negligible impact on turbine performance.

### BRIEF DESCRIPTION OF THE INVENTION

Aspects and advantages of the invention are set forth below in the following description, or may be obvious from the description, or may be learned through practice of the invention.

In an exemplary embodiment of the present disclosure, a method of measuring parameters of a gas turbine flow path is described. The method includes installing along one or more existing struts in the gas turbine flow path a first plurality of sensors for measuring a first parameter at one or more radial positions along the one or more struts and a second plurality of sensors for measuring a second parameter at one or more radial positions along the one or more struts. The method further includes collecting data related to the first parameter and second parameter from each of the first plurality of sensors and second plurality of sensors at the one or more struts. The data is used to calculate the gas turbine flow path first parameter at each of the first plurality of sensors of the one or more struts and the gas turbine flow path second parameter at each of the second plurality of sensors of the one or more struts. The gas turbine flow path first parameter at each of the first plurality of sensors is used to produce an actual profile of the gas turbine flow path first parameter. The gas turbine flow path second parameter at each of the second plurality of sensors is used to produce an actual profile of the gas turbine flow path second parameter.

In another exemplary embodiment of the present disclosure, a system for measuring parameters of a gas turbine flow path is described. The system includes one or more existing struts in the gas turbine flow path, a first plurality of sensors for measuring a first parameter at one or more radial positions along the one or more struts and a second plurality of sensors for measuring a second parameter at one or more radial positions along the one or more struts, and a computer system connected to the first plurality of sensors and the second plurality of sensors. The computer system performs steps which include collecting data related to the first parameter and second parameter from each of the first plurality of sensors and second plurality of sensors at the one or more struts. The data is used to calculate the gas turbine flow path first parameter at each of the first plurality of sensors of the one or more struts and the gas turbine flow path second parameter at each of the second plurality of sensors of the one or more struts. The gas turbine flow path first parameter at each of the first plurality of sensors is used to produce an actual profile of the gas turbine flow path first parameter. The gas turbine flow path second parameter at each of the second plurality of sensors is used to produce an actual profile of the gas turbine flow path second parameter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simple diagram showing the components of a typical gas turbine.

FIG. 2 is a plan view of a typical gas turbine exhaust frame, looking aft, with the exhaust frame including a plurality of exhaust struts.

FIG. 3 is a partial perspective view of a strut that is part of a gas turbine exhaust frame.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present invention relates to providing a real time, radial distribution of performance parameters within the gas turbine flow path of a gas turbine. Sensors are preferably installed at struts at a number of radial positions along the flow path. The data from the sensors in each strut is used to produce a normalized radial profile of certain gas turbine parameters. The existing station instrumentation is then used to expand the normalized radial profile into an actual profile of the parameters being measured. The calculations/transfer functions can be verified, or calibrated during performance testing with full rakes. Depending on the parameters being measured, the profiles can be integrated to improve the gas turbine control, including model-based controls or corrected parameter controls (MBC/CPC controls), or to provide protective action for bucket platforms, or other turbine components.

As used herein, the term “parameter” refers to any condition with the turbine flow path that can be measured. The present disclosure contemplates one or more parameters being measured by the mechanisms described herein, in particular one or more parameters being measured by the mechanisms described herein. A variety of sensors can be utilized to determine various parameters in connection with the present disclosure. For example, temperature sensors may monitor ambient temperature surrounding gas turbine engine system, compressor discharge temperature, turbine exhaust gas temperature, and other temperature measurements of the gas stream through the gas turbine engine. Pressure sensors may monitor ambient pressure, and static and dynamic pressure levels at the compressor inlet and outlet, turbine exhaust, at other locations in the gas stream through the gas turbine. Humidity sensors, such as wet and dry bulb thermometers, measure humidity in the inlet duct of the compressor. Sensors may also comprise flow sensors, temperature and pressure (static and dynamic), humidity, composition, gas composition sensors, and other sensors that sense various parameters relative to the operation of gas turbine engine system.

As discussed previously, the present disclosure relates to the measurement of different parameters in turbines without the addition of rakes or new structure for such purpose. Rather, multiple sensors are applied at a number of radial positions of any structural component spanning the flow path of the turbine. Such components can include inlet bell mouth struts, CDC struts, or the like. Sensor locations could be inside or outside the struts, at the struts' leading and/or trailing edges. A transfer function is defined between the strut parameter being measured and the same parameter in the flow path based on turbine commissioning data taken from performance rakes and/or analysis. Given the limited number of struts, and the lobed nature of the circumferential profile, variation swirl, etc., the sensors are not used to define an absolute parameter profile. Rather, they are used to define a characteristic, or normalized radial profile that is expanded to the actual radial profile using the turbine's existing station instrumentation.

A transfer function is used to calculate flow path parameters at each sensor installed inside or outside of the struts. Additional processing of the radial parameters from all struts using, for example, regression analysis, is then used to produce a normalized radial parameter profile. This approach addresses concerns of the circumferential distribution and measuring the radial profile at a limited number of circumferential locations. For example, the typical turbine station instrumentation is used to expand or calibrate the normalized profile, which can then be integrated into a bulk parameter, or could be fed into protective control loops such as to avoid excessive temperature at bucket platforms or for similar applications. Existing parameter measurements occur at one radial position, and a correction is applied to calculate a bulk parameter. This correction is not constant. It varies with load, combustor mode, etc. The present approach potentially provides the same benefit of production rakes with lower cost, and much higher reliability. It establishes the corrections to be made on a real-time basis for any given cycle condition or combustor split. It also provides additional information to control systems relative to a parameter at any radial location. When performance rakes are installed, each rake places a number of sensors at different radial positions along the turbine. Typically, there are a significant number of rakes positioned circumferentially to measure a particular parameter. Such a parameter can be non-uniform circumferentially. The performance rakes provide enough data throughout the flow field to allow the calculation of the average of the parameter.

The performance rakes can provide an optimal measurement of a given parameter, but they are not robust enough for long term use. For long term instrumentation (or “station” instrumentation) typically single sensors are mounted in the flow path at a single radial position, and at a large number (e.g., twenty seven) of circumferential positions. These account for circumferential parameter distributions, but do not capture radial distributions. To correct for the radial distribution, the average from the performance rakes is compared to the average from the station instrumentation. This ratio is then used to correct the station measurement to be consistent with the more accurate measurement. The design of the station instrumentation tries to target a radial position where the measured parameter will also be the average parameter. Therefore the ratio is typically close to 1.0. The average parameter value is typically used for gas turbine control and depends on this correction factor. Since the correction is typically determined empirically, near ISO day base load and a single value is used to provide the best understanding at base load. The parameter ratio may vary with load, ambient temperature, degradation, firing temperature or other factors depending on the particular parameter being measured.

A sensor centered between struts at a given radial position would typically have a “clean” measurement of a particular parameter. Another sensor mounted on the outside of a strut at the same radial position, could have thermal and aero effects that may cause it measure a different, but related measurement to that measured by the centered sensor. A transfer function is used that would be, for example, a function of total mass flow and exhaust pressure. The transfer function is dependent on the axial and radial location of the sensors on the strut. Thus, for example, the transfer function for the leading edge of the strut could be different from the transfer function for the trailing edge of the strut.

As described previously, the present disclosure contemplates one or more parameters being measured by the mechanisms described herein. A variety of sensors can be utilized to determine various parameters in connection with the present disclosure. In certain embodiments of the present disclosure, a first plurality of sensors can be utilized to measure a first parameter while a second plurality of sensors can be utilized to measure a second parameter. In one embodiment, one or more sensors are mounted on the outside surface of the strut. In another embodiment, one or more sensors are mounted inside the strut. This embodiment is desirable for having more protected and durable instrumentation. In this embodiment, the measurement inside the strut has a relationship to the measurement outside of the strut, and, in turn, the clean parameter. A transfer function is then used to relate the two values.

In another embodiment, a composite of the sensors is used. Where the existing station instrumentation provides an accurate circumferential measurement at one radial location, an account for the radial distribution is needed. All of the sensors on a single strut are used to define the radial profile at that strut. This profile is normalized, and all of the normalized profiles for all of the struts are averaged to define a normalized radial profile of a parameter. The measured parameter at the radial position of the station instrumentation is used to expand the normalized radial profile for use in the gas turbine control system. This composite or normalized approach can be used with sensors at any location on or in a strut.

The transfer functions may be determined by analysis, but, typically, they are developed by testing.

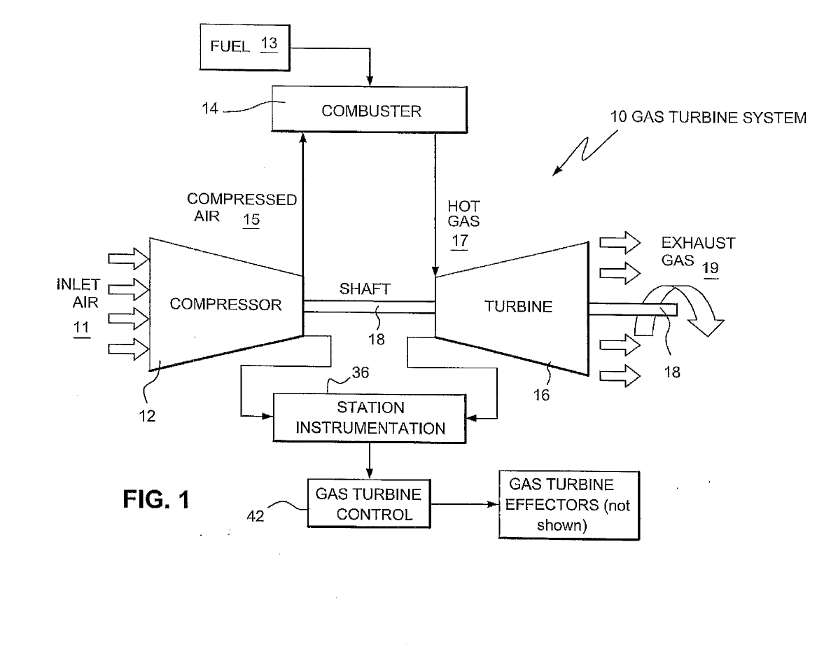

FIG. 1 is a simple diagram showing the components of a typical gas turbine system 10. The gas turbine system 10 includes (i) a compressor 12, which compresses incoming air 11 to high pressure, (ii) a combustor 14, which burns fuel 13 so as to produce a high-pressure, high-velocity hot gas 17, and (iii) a turbine 16, which extracts energy from the high-pressure, high-velocity hot gas 17 entering the turbine 16 from the combustor 14, so as to be rotated by the hot gas 17. As the turbine 16 is rotated, a shaft 18 connected to the turbine 16 and compressor 12 is caused to be rotated as well. Finally, exhaust gas 19 exits the turbine 16. The cycle conditions at various locations in the gas turbine are measured by long term instrumentation referred to as station instrumentation 36. This instrumentation provides input to the gas turbine's control system 42 which will change the gas turbine effectors as defined in the control laws.

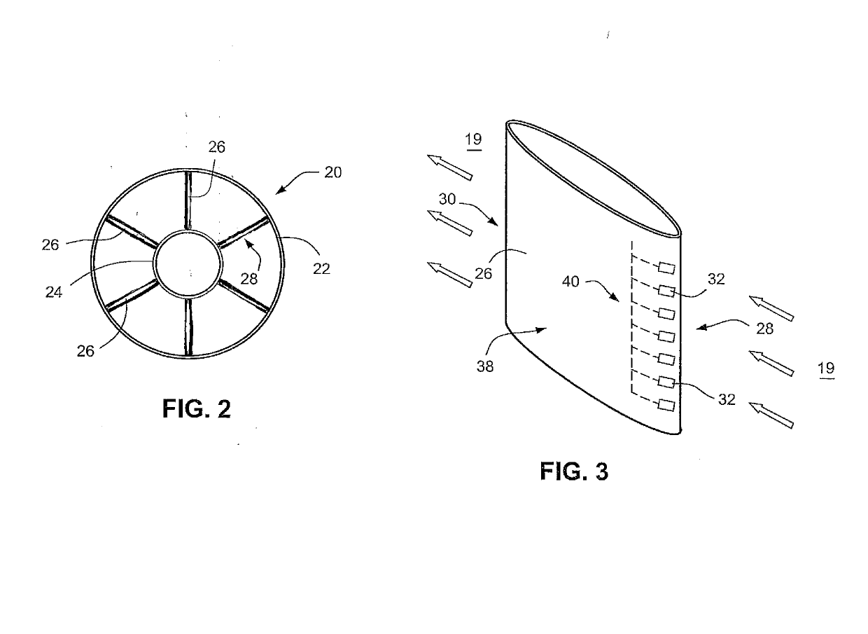

As discussed above, the present disclosure can be used in connection with any suitable structural component spanning the flow path of the turbine. For example, FIG. 2 is a plan view of turbine 16's exhaust frame 20, looking aft. The exhaust frame 20 includes an outer cylinder 22 and an inner cylinder 24 interconnected by a plurality of radially extending struts 26. The exhaust frame 20 typically receives a flow of exhaust gas 19 from turbine 16's exhaust diffuser (not shown).

In the exhaust frame 20 shown in FIG. 2, there are a total of six radially extending struts 26 interconnecting outer cylinder 22 and an inner cylinder 24. FIG. 3 is a partial perspective view in greater detail of one of the radially extending struts 26 interconnecting outer cylinder 22 and inner cylinder 24. Each of the struts 26 includes, relative to the exhaust gas 19 flowing from the turbine's exhaust diffuser, a leading edge 28 and a trailing edge 30.

A plurality of sensors 32 are installed along the surfaces 38 of the exhaust frame struts 26 at a number of positions extending radially from the inner cylinder 24. The sensors 32 shown in FIG. 3 are shown as being installed at multiple radial locations inside the skin 38 of each exhaust strut 26. The sensors 32 could be located, however, inside or outside the struts, and at the struts' leading and/or trailing edges. The sensor locations could also be a mixture of locations including inside and outside the struts, and at the struts' leading and trailing edges.

Parameter data from the sensors 32 in each of the struts 26 is used to produce a normalized radial profile of the particular parameter of turbine 16. The turbine's existing station instrumentation 36 is then used to expand the normalized profile into the actual profile of the turbine's particular parameter being measured. For this purpose, the turbine's existing station instrumentation 36 preferably includes a suitable computer system, which may be the gas turbine control system 42 for performing calculations used to develop profiles of the different parameters of turbine 16. The calculations/transfer functions for parameters are verified, or calibrated during performance testing with full rakes.

Although not specifically shown in FIG. 1, computer system 42 would typically include a central processing unit (CPU) and system bus that would couple various computer components to the CPU. The system buses may be any of several types of bus structures, including a memory bus or memory controller, a peripheral bus, and a local bus using any of a variety of bus architectures. The memory used by computer system 42 would also typically include random access memory (RAM) and one or more hard disk drives that read from, and write to, (typically fixed) magnetic hard disks. A basic input/output system (BIOS), containing the basic routines that help to transfer information between elements within a computer system, such as during start-up, may also be stored in read only memory (ROM). Computer system 42 might also include other types of drives for accessing other computer-readable media, such as removable “floppy” disks, or an optical disk, such as a CD ROM. The hard disk, floppy disk, and optical disk drives are typically connected to a system bus by a hard disk drive interface, a floppy disk drive interface, and an optical drive interface, respectively. The drives and their associated computer-readable media provide nonvolatile storage of computer-readable instructions, data structures, program modules, and other data used by machines, such as computer system 42. Computer system 42 will also include an input/output (I/O) device (not shown) and/or a communications device (not shown) for connecting to external devices, such as sensors 32. Such I/O and communications devices may be internal or external, and are typically connected to the computer's system bus via a serial or parallel port interface. Computer system 42 may also include other typical peripheral devices, such as printers, displays and keyboards. Typically, computer system 42 would include a display monitor (not shown), on which various information is displayed.

The method of the present invention for measuring certain parameter distributions in turbines improves the measurement of such parameter distributions without the addition of rakes. Rather, multiple sensors 32 are applied at a number of radial positions along the struts 26 of the flow path of the turbine 16. A transfer function is used to calculate flow path parameters at each sensor 32. Additional processing (e.g., regression analysis or the like) of the radial parameter from all struts 26 produces a normalized radial parameter profile. This approach addresses concerns of the circumferential distribution and measuring the radial profile at a limited number of circumferential locations. The station instrumentation 36 is used to expand or calibrate the normalized profile, which is then integrated into a bulk parameter, or could be fed into protective control loops as previously discussed.

The technical effect of the present matter is improved performance and/or operation of a gas turbine. In particular, potential benefits of the present method include improved control of emissions, improved hot gas path and HRSG life, increased peak fire capability by adjusting splits to minimize temperature at critical locations, and the like. Technical advantages of the present method include improved input to model based control systems to improve model tuning and improved understanding of different parameters into the HRSG.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of measuring parameters of a gas turbine flow path, the method comprising the steps of:
installing along one or more existing struts in the gas turbine flow path a first plurality of sensors for measuring a first parameter at one or more radial positions along the one or more struts and a second plurality of sensors for measuring a second parameter at one or more radial positions along the one or more struts;
collecting data related to the first parameter and second parameter from each of the first plurality of sensors and second plurality of sensors at the one or more struts;
using the data to calculate the gas turbine flow path first parameter at each of the first plurality of sensors of the one or more struts and the gas turbine flow path second parameter at each of the second plurality of sensors of the one or more struts;
using the gas turbine flow path first parameter at each of the first plurality of sensors to produce an actual profile of the gas turbine flow path first parameter; and
using the gas turbine flow path second parameter at each of the second plurality of sensors to produce an actual profile of the gas turbine flow path second parameter.

2. The method of claim 1, wherein a mathematical model is used to calculate the turbine gas flow path first parameter and second parameter from the strut sensor data.

3. The method of claim 1, wherein regression analysis is used to produce a normalized radial first parameter profile of the gas turbine first parameter from the gas flow path and a normalized radial second parameter profile of the gas turbine second parameter from the gas flow path.

4. The method of claim 1, wherein the first parameter comprises pressure in the gas turbine flow path and the first plurality of sensors comprise pressure sensors.

5. The method of claim 1, wherein the first parameter comprises pressure in the gas turbine flow path and the first plurality of sensors comprise pressure sensors.

6. The method of claim 5, wherein the second parameter comprises gas composition and the second plurality of sensors comprise gas composition sensors.

7. The method of claim 1 wherein the actual first and second profiles are used as input to the gas turbine control so as to provide protective action, improved performance, or combinations thereof, for selected turbine components.

8. The method of claim 7, wherein the selected turbine components are turbine buckets.

9. The method of claim 1, wherein the first plurality of sensors, second plurality of sensors, or combinations thereof are installed on or inside the one or more struts at leading edges of the one or more struts.

10. The method of claim 1, wherein the first plurality of sensors, second plurality of sensors, or combinations thereof are installed on or inside the one or more struts at trailing edges of the one or more struts.

11. The method of claim 1, wherein the first plurality of sensors, second plurality of sensors, or combinations thereof are installed on the one or more struts between the leading edges and trailing edges of the one or more struts.

12. The method of claim 1, wherein the first plurality of sensors, second plurality of sensors, or combinations thereof are installed inside the one or more struts between the leading edges and trailing edges of the one or more struts.

13. A system for measuring parameters of a gas turbine flow path, the system comprising:
one or more existing struts in the gas turbine flow path;
a first plurality of sensors for measuring a first parameter at one or more radial positions along the one or more struts and a second plurality of sensors for measuring a second parameter at one or more radial positions along the one or more struts; and
a computer system connected to the first plurality of sensors and the second plurality of sensors, the computer system performing the steps of:
collecting data related to the first parameter and second parameter from each of the first plurality of sensors and second plurality of sensors at the one or more struts;
using the data to calculate the gas turbine flow path first parameter at each of the first plurality of sensors of the one or more struts and the gas turbine flow path second parameter at each of the second plurality of sensors of the one or more struts;
using the gas turbine flow path first parameter at each of the first plurality of sensors to produce an actual profile of the gas turbine flow path first parameter; and
using the gas turbine flow path second parameter at each of the second plurality of sensors to produce an actual profile of the gas turbine flow path second parameter.

14. The system of claim 13, wherein a mathematical model is used to calculate the turbine gas flow path first parameter and second parameter from the strut sensor data.

15. The system of claim 14, wherein regression analysis is used to produce a normalized radial first parameter profile of the gas turbine first parameter from the gas flow path and a normalized radial second parameter profile of the gas turbine second parameter from the gas flow path.

16. The system of claim 13, wherein the first parameter comprises pressure in the gas turbine flow path and the first plurality of sensors comprise pressure sensors.

17. The system of claim 16, wherein the second parameter comprises gas composition and the second plurality of sensors comprise gas composition sensors.

18. The system of claim 13, wherein the first plurality of sensors, second plurality of sensors, or combinations thereof are installed on or inside the one or more struts at leading edges, trailing edges, or between the leading edges and trailing edges of the one or more struts.

19. The system of claim 13, wherein the first plurality of sensors, second plurality of sensors, or combinations thereof are installed on or inside the surface of the one or more struts at leading edges, trailing edges, or between the leading edges and trailing edges of the one or more struts.

20. The system of claim 13, wherein gas turbine station instrumentation is used to expand the normalized radial first parameter and second parameter profiles into the actual profiles of the respective gas turbine parameters.
